(19) United States
(12) Patent Application Publication
(10) Pub. No.: US 2024/0276515 A1
(43) Pub. Date: Aug. 15, 2024

(54) DOWNLINK CONTROL INFORMATION FORMAT FOR MULTI-CELL SCHEDULING

(71) Applicant: QUALCOMM Incorporated, San Diego, CA (US)

(72) Inventors: Kazuki TAKEDA, Minato-ku (JP); Peter GAAL, San Diego, CA (US); Mostafa KHOSHNEVISAN, San Diego, CA (US); Gokul SRIDHARAN, Sunnyvale, CA (US)

(21) Appl. No.: 18/168,942

(22) Filed: Feb. 14, 2023

(51) Int. Cl. H04W 72/232; H04W 72/12

(52) U.S. Cl. CPC H04W 72/232; H04W 72/12

(57) ABSTRACT

Various aspects of the present disclosure generally relate to wireless communication. In some aspects, a user equipment (UE) may receive a multi-cell scheduling downlink control information (DCI) communication including a co-scheduled cell indicator field that indicates one or more cells that are scheduled by the DCI communication. The UE may identify a bitwidth associated with a field of the DCI communication based at least in part on a configuration of the co-scheduled cell indicator field. Numerous other aspects are described.

### FIELD OF THE DISCLOSURE

Aspects of the present disclosure generally relate to wireless communication and to techniques and apparatuses for a downlink control information format for multi-cell scheduling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5 G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a multi-cell scheduling downlink control information (DCI) communication including a co-scheduled cell indicator field that indicates one or more cells that are scheduled by the DCI communication. The method may include identifying a bitwidth associated with a field of the DCI communication based at least in part on a configuration of the co-scheduled cell indicator field.

Some aspects described herein relate to a method of wireless communication performed by a network node. The method may include transmitting, to a UE, a configuration of a co-scheduled cell indicator field associated with a multi-cell scheduling DCI communication. The method may include transmitting, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field.

Some aspects described herein relate to a UE for wireless communication. The UE may include a memory and one or more processors coupled to the memory. The one or more processors may be configured to receive a multi-cell scheduling DCI communication including a co-scheduled cell indicator field that indicates one or more cells that are scheduled by the DCI communication. The one or more processors may be configured to identify a bitwidth associated with a field of the DCI communication based at least in part on a configuration of the co-scheduled cell indicator field.

Some aspects described herein relate to a network node for wireless communication. The network node may include a memory and one or more processors coupled to the memory. The one or more processors may be configured to transmit, to a UE, a configuration of a co-scheduled cell indicator field associated with a multi-cell scheduling DCI communication. The one or more processors may be configured to transmit, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field.

Some aspects described herein relate to a non-transitory computer-readable medium that stores a set of instructions for wireless communication by a UE. The set of instructions, when executed by one or more processors of the UE, may cause the UE to receive a multi-cell scheduling DCI communication including a co-scheduled cell indicator field that indicates one or more cells that are scheduled by the DCI communication. The set of instructions, when executed by one or more processors of the UE, may cause the UE to identify a bitwidth associated with a field of the DCI communication based at least in part on a configuration of the co-scheduled cell indicator field.

Some aspects described herein relate to a non-transitory computer-readable medium that stores a set of instructions for wireless communication by a network node. The set of instructions, when executed by one or more processors of the network node, may cause the network node to transmit, to a UE, a configuration of a co-scheduled cell indicator field associated with a multi-cell scheduling DCI communication. The set of instructions, when executed by one or more processors of the network node, may cause the network node to transmit, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field.

Some aspects described herein relate to an apparatus for wireless communication. The apparatus may include means for receiving a multi-cell scheduling DCI communication including a co-scheduled cell indicator field that indicates one or more cells that are scheduled by the DCI communication. The apparatus may include means for identifying a bitwidth associated with a field of the DCI communication based at least in part on a configuration of the co-scheduled cell indicator field.

Some aspects described herein relate to an apparatus for wireless communication. The apparatus may include means for transmitting, to a UE, a configuration of a co-scheduled cell indicator field associated with a multi-cell scheduling DCI communication. The apparatus may include means for transmitting, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIGS. 5A-5B are diagrams illustrating an example of a downlink control information (DCI) that schedules multiple cells, in accordance with the present disclosure.

FIGS. 6A-6G are diagrams illustrating an example associated with a DCI format for multi-cell scheduling, in accordance with the present disclosure.

FIG. 7 is a diagram of another example associated with a DCI format for multi-cell scheduling, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A network node may schedule communications with a user equipment (UE) using downlink control information (DCI). For example, a network node may schedule an uplink data communication, such as a communication using a physical uplink shared channel (PUSCH), or a downlink data communication, such as a communication using a physical downlink shared channel (PDSCH), using DCI. In some cases, such as cases in which the network node and/or the UE are operating in a carrier aggregation mode, a network node may schedule multiple cells using a single DCI communication, sometimes referred to as a multi-cell scheduling DCI communication. The multi-cell scheduling DCI communication may include a co-scheduled cell indicator field indicating a set of cells to be scheduled by the DCI communication (e.g., indicating a set of cells to be scheduled with a PUSCH or a PDSCH). In such cases, a quantity of cells that may be scheduled using the multi-cell scheduling DCI communication may vary, and thus fields associated with the DCI communication may vary in size from one DCI communication to another DCI communication. For example, a frequency domain resource allocation (FDRA) field associated with a DCI communication scheduling four cells may be larger (e.g., include more total bits) than an FDRA field associated with a DCI communication scheduling only two cells. Because certain fields may have varying sizes, in some cases the network node may need to signal to the UE one or more field sizes associated with the DCI communication, resulting in high overhead, or else the varying field sizes may result communication errors, leading to high power, computing, and network resource consumption to correct communication errors.

Some techniques and apparatuses described herein enable a UE to identify a bitwidth of one or more fields of a DCI communication without supplemental signaling from the network node, thereby reducing overhead and improving a decoding process of the DCI communication at the UE. In some aspects, a UE may receive a multi-cell scheduling DCI communication that includes a co-scheduled cell indicator field indicating one or more cells that are scheduled by the DCI communication, and the UE may identify a bitwidth associated with a field of the DCI communication based at least in part on a configuration of the co-scheduled cell indicator field. For example, the UE may identify the bitwidth based at least in part on a necessary quantity of bits for the field in connection with the co-scheduled cell indicator field indicating a set of cells that maximize the bitwidth of the field. In some aspects, when a set of cells indicated by the co-scheduled cell indicator is a set of cells that does not maximize the bitwidth of the field, the UE may determine a quantity of bits actually used for the field and/or a location of other fields in the DCI communication relative to the field based at least in part on the quantity of bits actually used for the field. As a result, signaling overhead associated with the network node indicating certain bitwidths to the UE for a given DCI communication may be reduced or eliminated, and/or communication errors resulting from varying field sizes in multi-cell scheduling DCI communications may be reduced, thus reducing power, computing, and network resource consumption that would otherwise be needed to correct communication errors.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5 G or New Radio (NR) radio access technology (RAT), aspects of the present disclosure can be applied to other RATs, such as a 3 G RAT, a 4 G RAT, and/or a RAT subsequent to 5 G (e.g., 6 G).

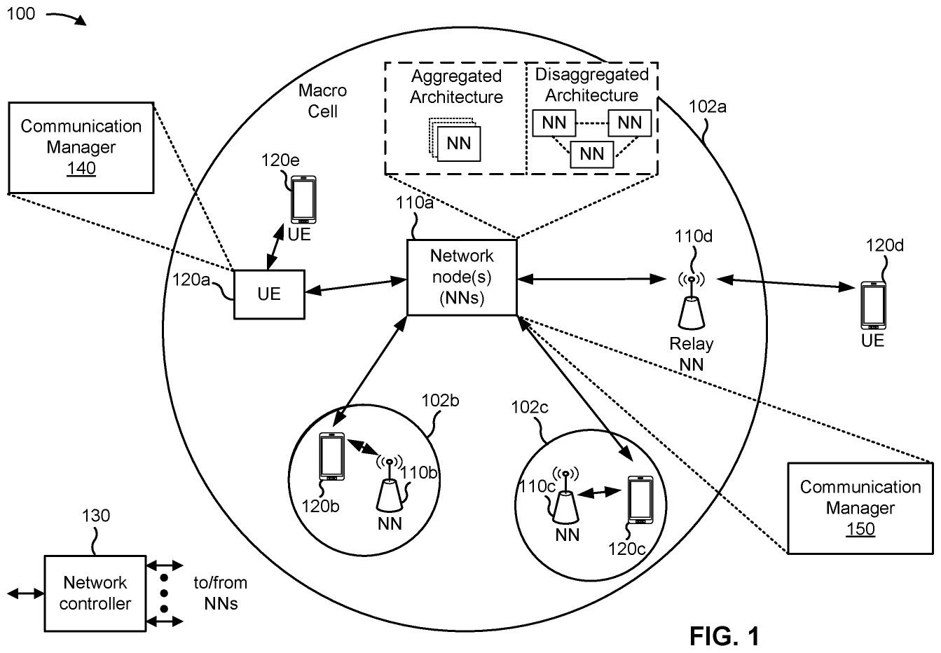

FIG. 1 is a diagram illustrating an example of a wireless network 100, in accordance with the present disclosure. The wireless network 100 may be or may include elements of a 5 G (e.g., NR) network and/or a 4 G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4 G), a gNB (e.g., in 5 G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5 G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5 G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5 G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5 G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a multi-cell scheduling DCI communication including a co-scheduled cell indicator field that indicates one or more cells that are scheduled by the DCI communication; and identify a bitwidth associated with a field of the DCI communication based at least in part on a configuration of the co-scheduled cell indicator field. Additionally, or alternatively, the communication manager 140 may perform one or more other operations described herein.

In some aspects, the network node 110 may include a communication manager 150. As described in more detail elsewhere herein, the communication manager 150 may transmit, to a UE, a configuration of a co-scheduled cell indicator field associated with a multi-cell scheduling DCI communication; and transmit, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field. Additionally, or alternatively, the communication manager 150 may perform one or more other operations described herein.

As indicated above, FIG. 1 is provided as an example. Other examples may differ from what is described with regard to FIG. 1.

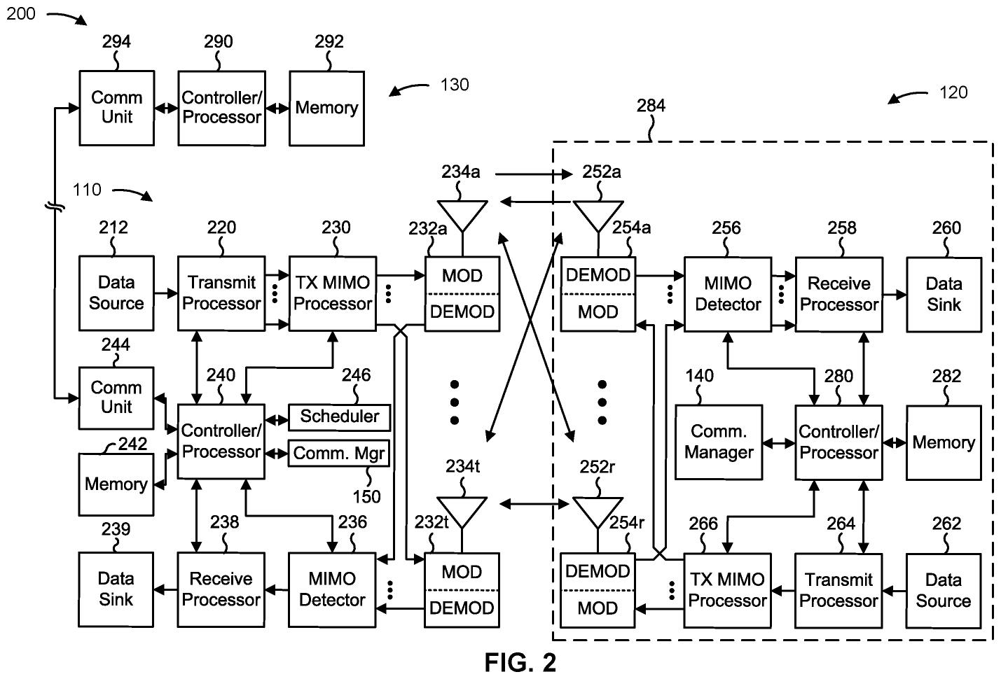

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

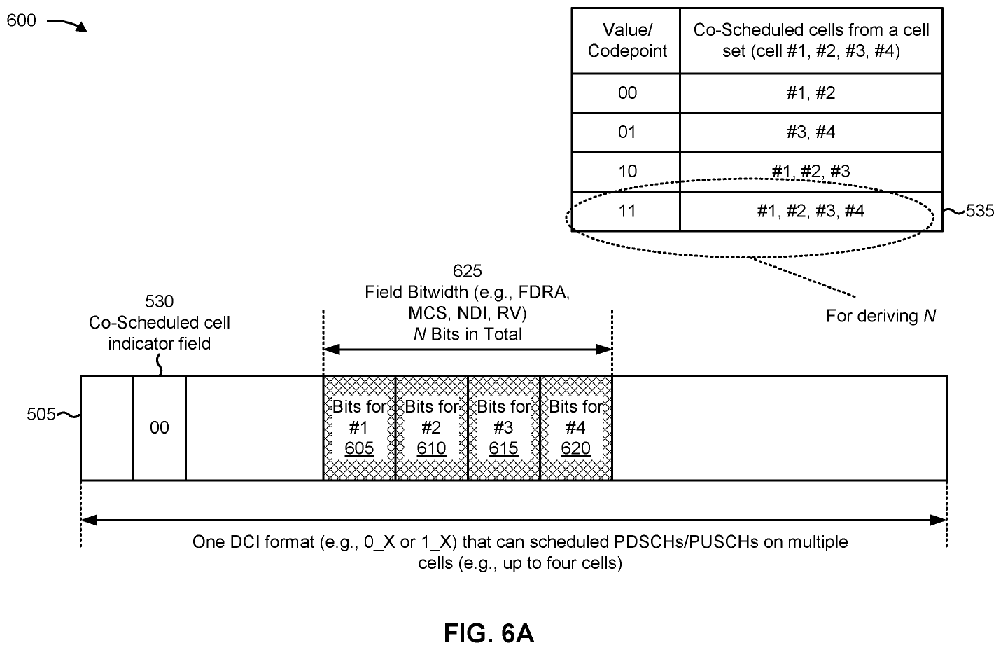

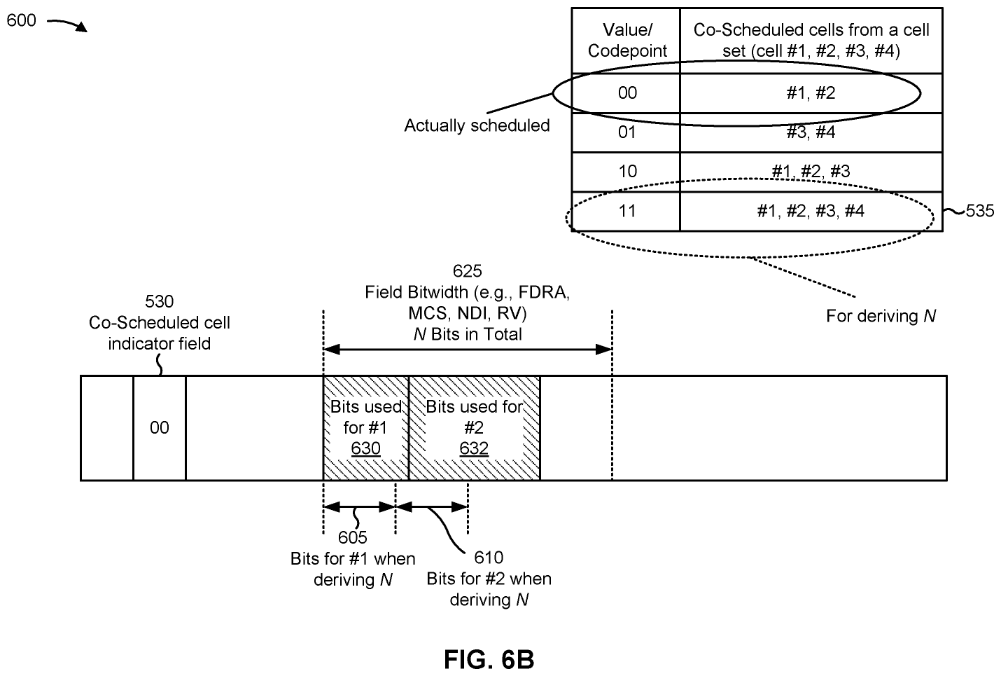

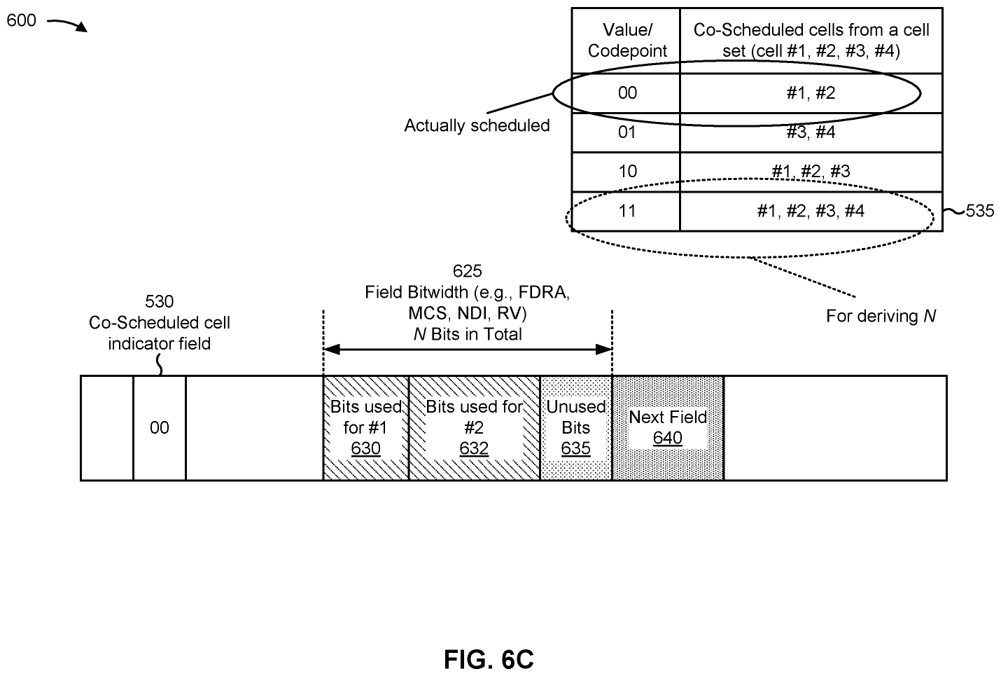

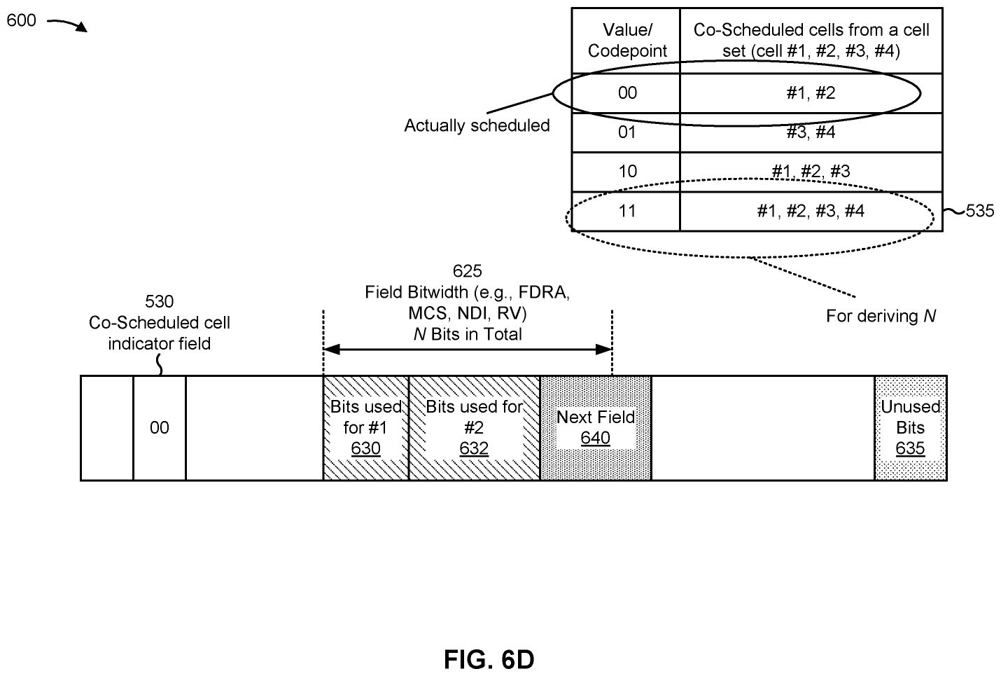

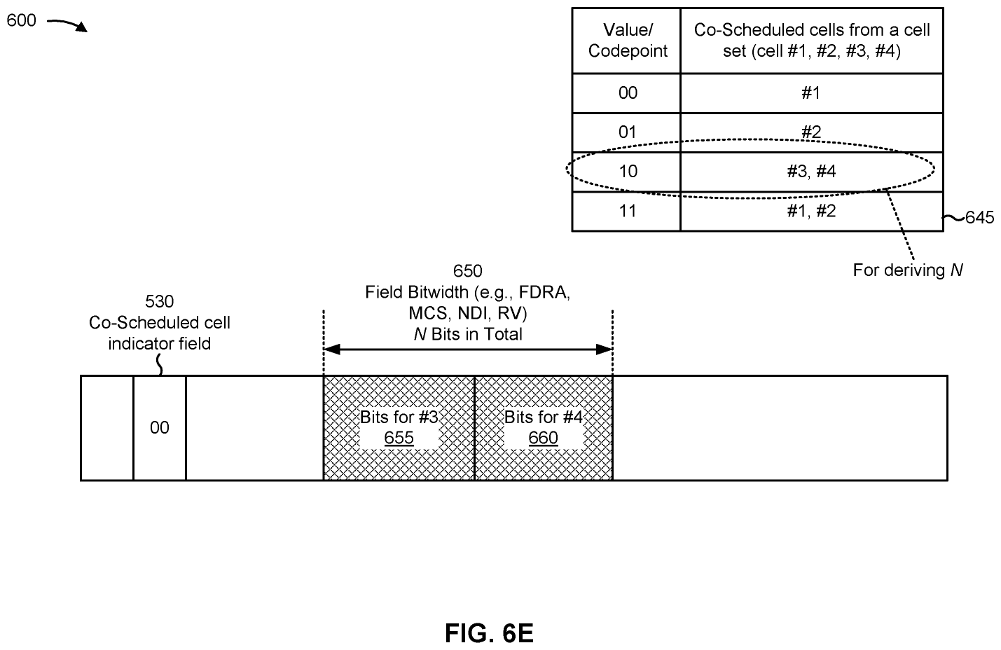

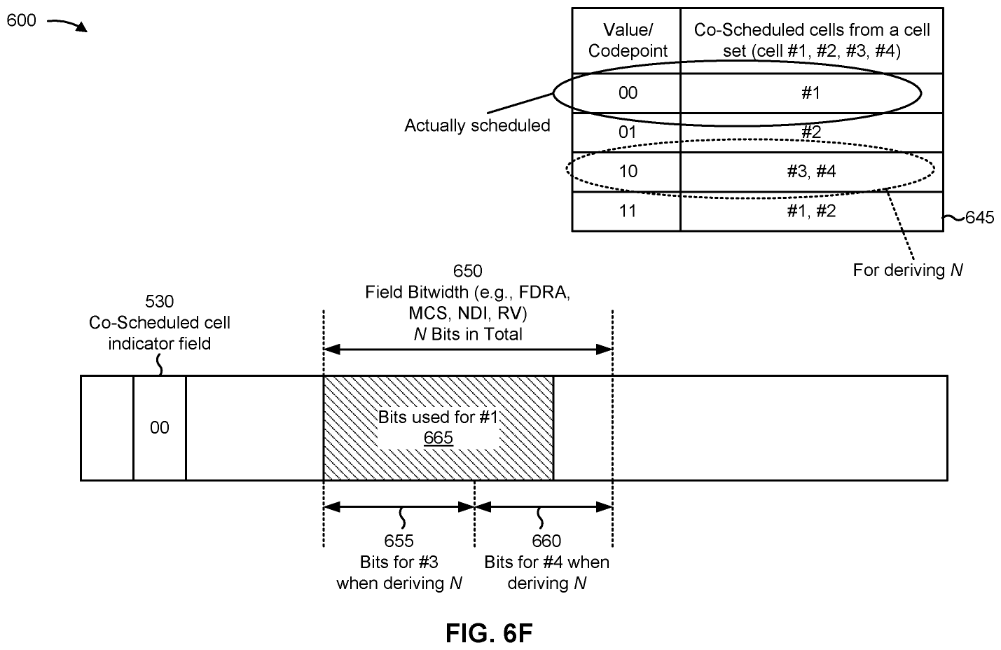

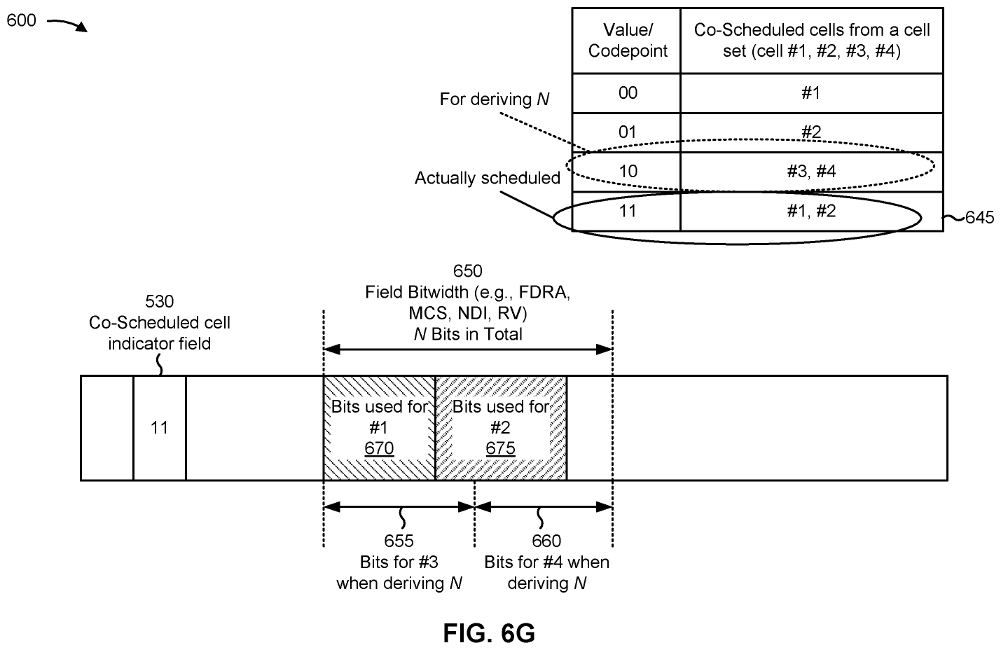

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-11).

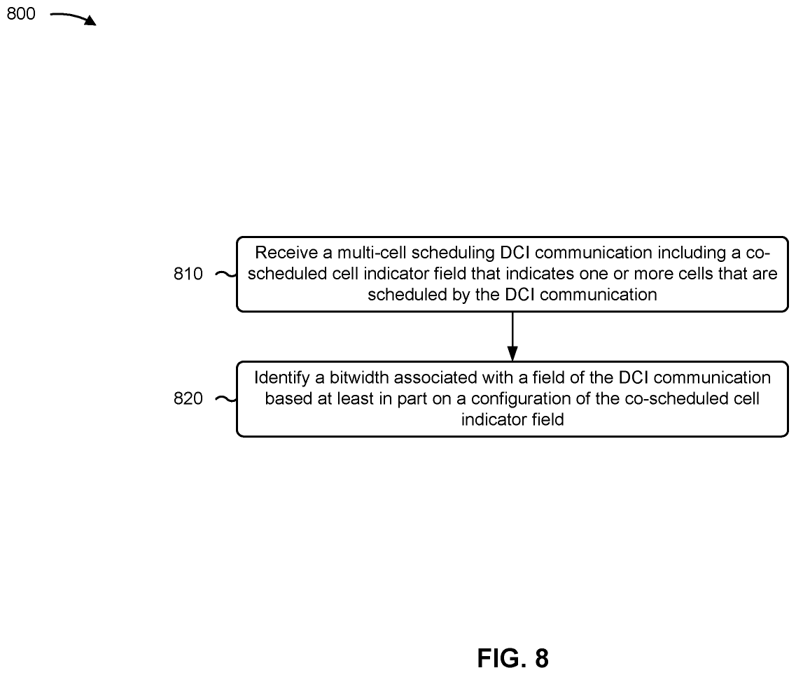

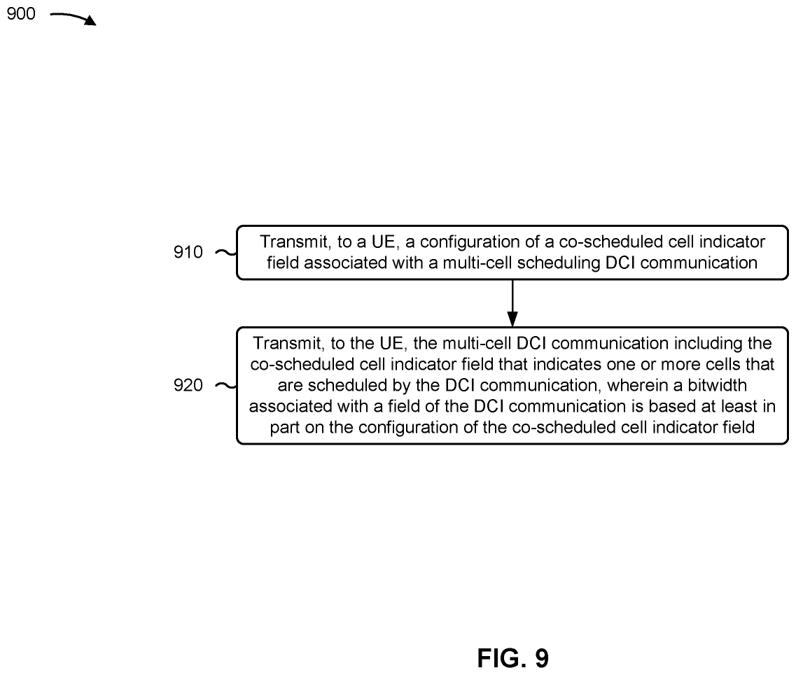

The controller/processor 240 of the network node 110, the controller/processor 280 of the UE 120, and/or any other component(s) of FIG. 2 may perform one or more techniques associated with a DCI format for multi-cell scheduling, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving a multi-cell scheduling DCI communication including a co-scheduled cell indicator field that indicates one or more cells that are scheduled by the DCI communication; and/or means for identifying a bitwidth associated with a field of the DCI communication based at least in part on a configuration of the co-scheduled cell indicator field. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, a configuration of a co-scheduled cell indicator field associated with a multi-cell scheduling DCI communication; and/or means for transmitting, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5 G NR systems, may be arranged in multiple manners with various components or constituent parts. In a 5 G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5 G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

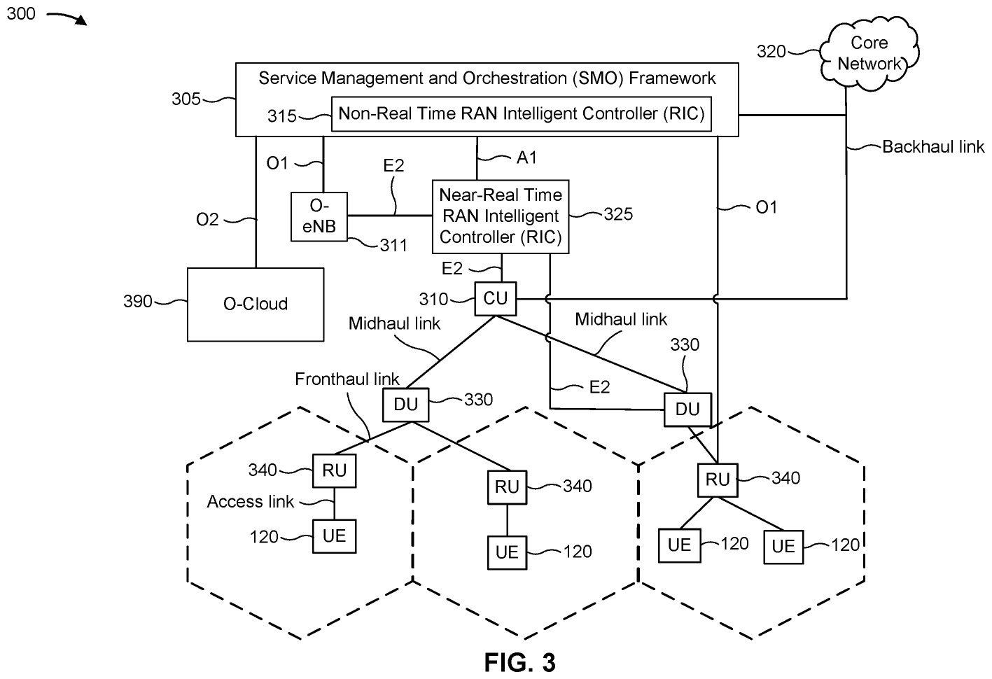

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-Rt RICs 325. In some implementations, the SMO Framework 305 can communicate with a hardware aspect of a 4 G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

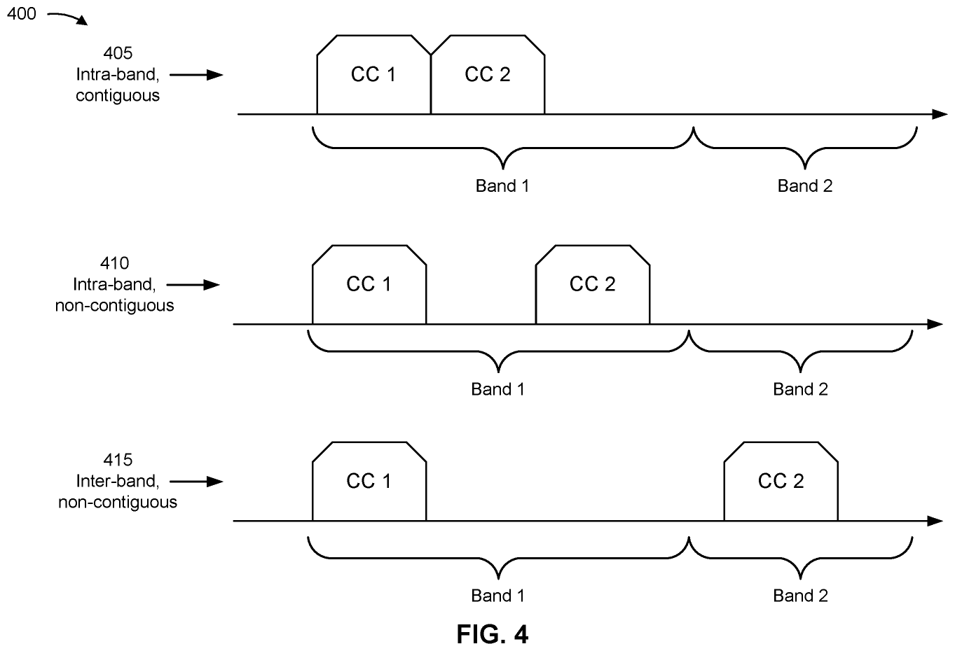

FIG. 4 is a diagram illustrating examples 400 of carrier aggregation, in accordance with the present disclosure.

Carrier aggregation is a technology that enables two or more component carriers (CCs, sometimes referred to as carriers or cells) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, a DCI, and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., DCI and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

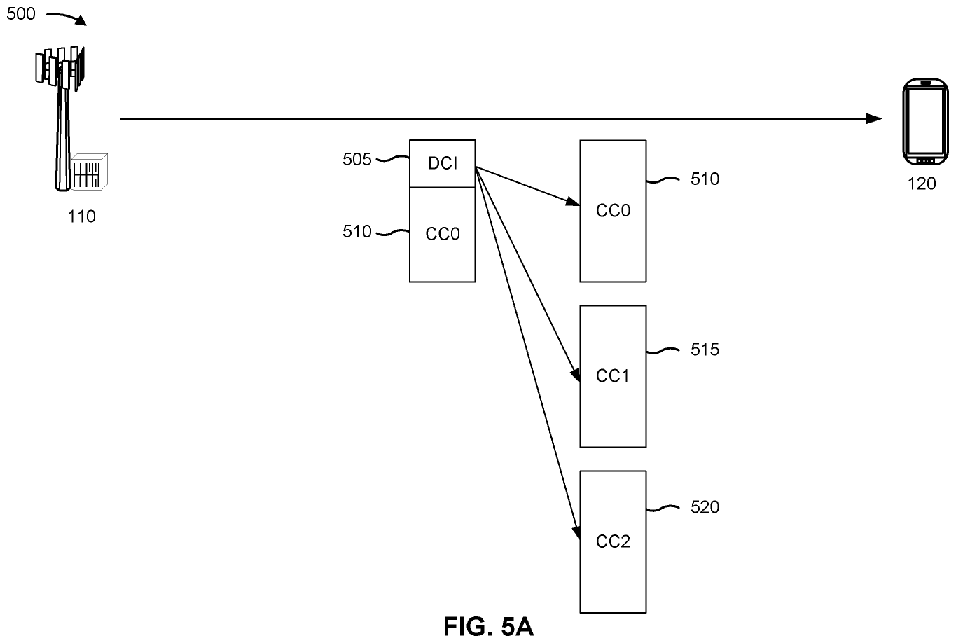

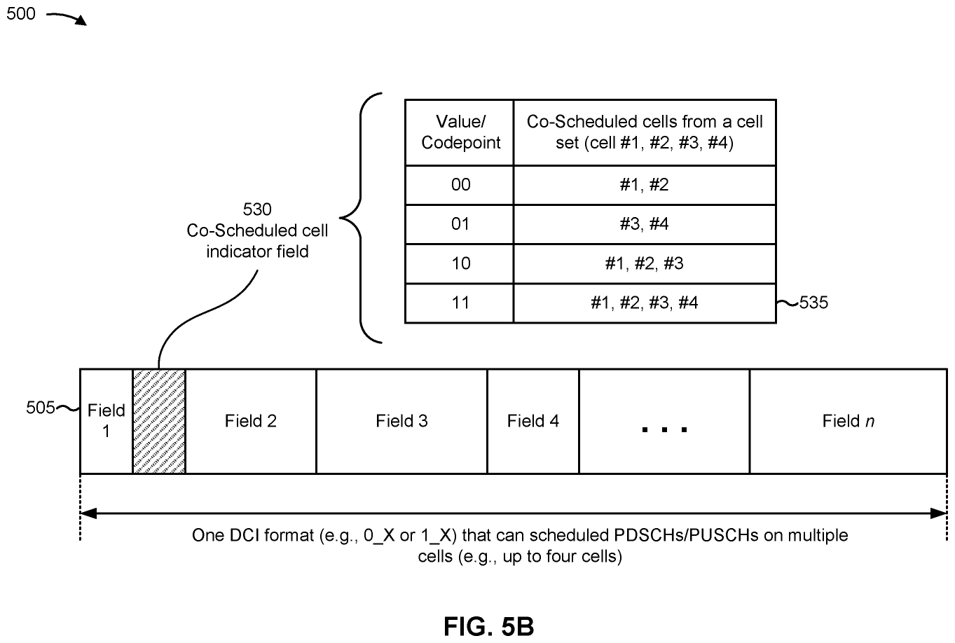

In some aspects, a single DCI communication may be used to schedule communications on multiple cells, which is sometimes referred to as a multi-cell scheduling DCI communication. For example, a multi-cell scheduling DCI communication may be used to schedule a PUSCH on up to four cells, and/or a multi-cell scheduling DCI communication may be used to schedule a PDSCH on up to four cells. Aspects of multi-cell scheduling DCI communications are described in more detail in connection with FIGS. 5A-5B.

As indicated above, FIG. 4 is provided as an example. Other examples may differ from what is described with regard to FIG. 4.

FIGS. 5A-5B are diagrams illustrating an example 500 of a DCI that schedules multiple cells, in accordance with the present disclosure. As shown in FIG. 5, a network node 110 and a UE 120 may communicate with one another (e.g., directly or via one or more network nodes).

The network node 110 may transmit, to the UE 120 (e.g., directly or via one or more network nodes), a multi-cell scheduling DCI 505 that schedules multiple communications for the UE 120. The multiple communications may be scheduled for one or more cells (e.g., one or more CCs). In some cases, a DCI that schedules a communication for a cell via which the DCI is transmitted may be referred to as self-carrier (or self-cell) scheduling DCI. In some cases, a DCI that schedules a communication for a cell via which the DCI is transmitted may be referred to as cross-carrier (or cross-cell) scheduling DCI. In some aspects, the multi-cell scheduling DCI 505 may be a cross-carrier scheduling DCI, and may or may not be a self-carrier scheduling DCI. In some aspects, the multi-cell scheduling DCI 505 that carries communications in at least two cells may be referred to as combination DCI.

In example 500, the multi-cell scheduling DCI 505 schedules a communication for a first cell 510 that carries the multi-cell scheduling DCI 505 (shown as CC0), the multi-cell scheduling DCI 505 schedules a communication for a second cell 515 that does not carry the multi-cell scheduling DCI 505 (shown as CC1), and the multi-cell scheduling DCI 505 schedules a communication for a third cell 520 that does not carry the multi-cell scheduling DCI 505 (shown as CC2). In some aspects, the multi-cell scheduling DCI 505 may schedule communications on a different quantity of cells than shown in FIG. 5 (e.g., two cells, four cells, five cells, and so on). The quantity of cells may be greater than or equal to two.

A communication scheduled by the multi-cell scheduling DCI 505 may include a data communication, such as a PDSCH communication or a PUSCH communication. A multi-cell scheduling DCI 505 used to schedule a PUSCH communication on up to four cells is sometimes referred to as a DCI format 0_X communication (with “X” corresponding to an numeral yet to be determined, such that the multi-cell scheduling DCI 505 used to schedule a PUSCH communication may ultimately be referred to as a DCI format 03, a DCI format 04, or the like), and a multi-cell scheduling DCI 505 used to schedule a PDSCH communication on up to four cells is sometimes referred to as a DCI format 1_X communication (with “X” again corresponding to an numeral yet to be determined, such that the multi-cell scheduling DCI 505 used to schedule a PDSCH communication may ultimately be referred to as a DCI format 13, a DCI format 14, or the like). For a data communication, the multi-cell scheduling DCI 505 may schedule a single transport block (TB) across multiple cells or may separately schedule multiple TBs in the multiple cells. Additionally, or alternatively, a communication scheduled by the multi-cell scheduling DCI 505 may include a reference signal, such as a channel state information reference signal (CSI-RS) or a sounding reference signal (SRS). For a reference signal, the multi-cell scheduling DCI 505 may trigger a single resource for reference signal transmission across multiple cells or may separately schedule multiple resources for reference signal transmission in the multiple cells. In some cases, scheduling information in the multi-cell scheduling DCI 505 may be indicated once and reused for multiple communications (e.g., on different cells), such as a MCS, a resource to be used for acknowledgement (ACK) or negative acknowledgement (NACK) of a communication scheduled by the multi-cell scheduling DCI 505, and/or a resource allocation for a scheduled communication, to conserve signaling overhead.

Additionally, or alternatively, some fields of the multi-cell scheduling DCI 505 may indicate separate information for each cell being scheduled by the multi-cell scheduling DCI 505 (sometimes referred to as per-cell fields), some fields of the multi-cell scheduling DCI 505 may indicate common information applicable to all cells being scheduled by the multi-cell scheduling DCI 505 (sometimes referred to as single fields), and some fields may be configurable between a per-cell field and a single field. For example, an FDRA field of the multi-cell scheduling DCI 505 may be a per-cell field, meaning that separate FDRA information may be indicated for each cell being scheduled by the multi-cell scheduling DCI 505. Similarly, an MCS field, a new data indicator (NDI) field, a redundancy version (RV) field, and/or a hybrid automatic repeat request (HARQ) process number field may be per-cell fields. Moreover, an antenna ports field may be configurable between a per-cell field or a single field.

In some examples, the multi-cell scheduling DCI 505 may include additional single fields, such as a bandwidth part (BWP) indicator field, a time domain resource allocation (TDRA) field, a virtual resource block (VRB) to physical resource block (PRB) mapping field, a PRB bundling size field, a rate matching indicator field, a zero power (ZP) CSI-RS trigger field, a transmission configuration indicator (TCI) field, a DMRS sequence initialization field, an SRS request field, an SRS offset field, a frequency hopping (FH) flag field, an open-loop power control (OLPC) field, and/or an uplink (UL)/supplemental UL (SUL) indicator field, among other examples. Additionally, or alternatively, the multi-cell scheduling DCI 505 may include additional per-cell fields, such as a PUSCH transmit power control (TPC) field, a phase tracking reference signal (PTRS)-DMRS association field, and/or the UL/SUL indicator field, among other examples. Additionally, or alternatively, the multi-cell scheduling DCI 505 may include additional fields that are configurable between a single field and a per-cell field, such as a precoding and number of layers field, and/or an SRS resource indicator field, among other examples.

As shown in FIG. 5B, in some examples the multi-cell scheduling DCI 505 may include a co-scheduled cell indicator field 530. In some examples, the co-scheduled cell indicator field 530 may indicate a codepoint corresponding to a subset of cells being scheduled by the multi-cell scheduling DCI 505, with the subset of cells being equal to one or more cells of a configured set of cells (including, in some aspects, all of the cells in the configured set of cells) that may potentially be scheduled by the multi-cell scheduling DCI 505. For example, a UE 120 may be configured with a table 535 or similar information that associates various codepoints with one or more cells of a configured set of cells, such as cell #1, cell #2, cell #3, and cell #4. In the example shown in FIG. 5B, the table 535 may associate a codepoint of 00 with a first subset of the set of cells (e.g., cell #1 and cell #2), a codepoint of 01 with a second subset of the set cells (e.g., cell #3 and cell #4), a codepoint of 10 with a third subset of the set of cells (e.g., cell #1, cell #2, and cell #3), and a codepoint of 11 with a fourth subset of the set of cells (e.g., cell #1, cell #2, cell #3, and cell #4). Put another way, in some examples, for a set of cells which is configured for multi-cell scheduling (e.g., cell #1, cell #2, cell #3, and cell #4), the subset of cells that are being co-scheduled by the multi-cell scheduling DCI 505 may be indicated by the co-scheduled cell indicator field 530 in the multi-cell scheduling DCI 505 (e.g., DCI format 0_X and/or DCI format 1_X), with the co-scheduled cell indicator field 530 pointing to one row of a table defining combinations of co-scheduled cells for the set of cells. In some cases, the table 535 may be configured by RRC signaling for the set of cells. Moreover, the size of the co-scheduled cell indicator field 530 may be determined based at least in part on the quantity of rows in the table. In the example depicted in FIG. 5B, the table 535 includes four rows (e.g., four combinations of co-scheduled cells for the set of cells), and thus the size of the co-scheduled cell indicator field 530 may be two bits (e.g., ┌ log 2(4)┐=2 bits) in order to indicate one of the four possible subsets of cells. More broadly, for a table including M rows and/or entries, the size of a corresponding co-scheduled cell indicator field may be equal to ┌ log 2(M)┐.

In some aspects, a size of one or more per-cell fields of a multi-cell scheduling DCI 505 and/or a quantity of bits actually used within one or more per-cell fields of a multi-cell scheduling DCI 505 may vary according to a configuration of the co-scheduled cell indicator field 530 and/or a quantity of cells being scheduled by the multi-cell scheduling DCI 505. More particularly, in the example shown in FIG. 5B, a per-cell field the multi-cell scheduling DCI 505 (such as an FDRA field or a similar field) may need to be large enough to indicate FDRA information for up to four cells (corresponding to the subset of cells including cell #1, cell #2, cell #3, and cell #4). However, in examples in which the multi-cell scheduling DCI 505 schedules less than four cells (e.g., when the co-scheduled cell indicator field 530 indicates one of codepoints 00, 01, or 10), the quantity of bits used for the field may be less than the bitwidth of the entire field. Moreover, in aspects in which the UE 120 is configured with a table that only includes proper subsets of the set of cells (e.g., in which every possible combination of co-scheduled cells is less than all of cell #1, cell #2, cell #3, and cell #4), a bitwidth of a per-cell field the multi-cell scheduling DCI 505 (such as an FDRA field or a similar field) may be smaller than in the above example where up to four cells may be co-scheduled because the field only needs to be large enough to indicate FDRA information for less than four cells. This variation in bitwidth of certain per-cell fields and/or the quantity of bits used for certain per-cell fields may require high signaling overhead associated with the network node 110 indicating certain bitwidths to the UE 120 for a given DCI communication, or else may lead to communication errors between the network node 110 and the UE 120, and thus may result in high power, computing, and network resource consumption to correct communication errors.

Some techniques and apparatuses described herein enable a UE 120 to identify a bitwidth of a per-cell field of a DCI communication, a quantity of bits that are associated with the per-cell field, and/or relative locations of DCI fields, thereby improving a decoding of the DCI communication at the UE 120 and thus reducing communication errors between a network node 110 and the UE 120. In some aspects, a UE 120 may receive a multi-cell scheduling DCI communication that includes a co-scheduled cell indicator field indicating one or more cells that are scheduled by the DCI communication, and the UE 120 may identify a bitwidth associated with a field of the DCI communication based at least in part on a configuration of the co-scheduled cell indicator field. For example, the UE 120 may identify the bitwidth based at least in part on a necessary quantity of bits for the field in connection with the co-scheduled cell indicator field indicating a subset of cells that maximizes the bitwidth. Additionally, or alternatively, when a subset of cells indicated by the co-scheduled cell indicator is a subset of cells that does not maximize the bitwidth, the UE 120 may determine a quantity of bits actually used for the field and/or a location of other fields in the DCI communication relative to the field. As a result, communication errors associated with a multi-cell scheduling DCI communication may be reduced, thereby reducing power, computing, and network resource consumption that would otherwise be needed to correct communication errors, and/or signaling overhead associated with the network node 110 indicating certain bitwidths to the UE 120 for a given DCI communication may be reduced or eliminated.

As indicated above, FIGS. 5A-5B are provided as examples. Other examples may differ from what is described with respect to FIGS. 5A-5B.

FIGS. 6A-6G are diagrams illustrating an example 600 associated with a DCI format for multi-cell scheduling, in accordance with the present disclosure. Example 600 may be associated with a communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 6A, the UE 120 and the network node 110 may communicate using a multi-cell scheduling DCI 505, as described above in connection with FIGS. 5A-5B. In that regard, the multi-cell scheduling DCI 505 may include a co-scheduling cell indicator field 530 that indicates a codepoint associated with a subset of cells, of a configured set of cells, that are co-scheduled by the multi-cell scheduling DCI 505 (e.g., a subset of cells co-scheduled with a PUSCH in aspects in which the multi-cell scheduling DCI 505 is associated with a DCI format 0_X communication, or a subset of cells co-scheduled with a PDSCH in aspects in which the multi-cell scheduling DCI 505 is associated with a DCI format 1_X communication). More particularly, the UE 120 may receive (e.g., via RRC signaling) a configuration of the co-scheduled cell indicator field 530, which may indicate a table (e.g., table 535) associating sets of cells (e.g., cell #1, cell #2, cell #3, and cell #4) with various codepoints, and the co-scheduled cell indicator field 530 may indicate one codepoint, of the multiple codepoints in the table, that corresponds to the subset of cells being co-scheduled by the multi-cell scheduling DCI 505. Although a table has been described herein for ease of discussion, in some other aspects, a different data structure may be used to associate sets of cells with various codepoints. For example, the configuration of the co-scheduled cell indicator field 530 may indicate a list of parameters, with the number of entries in the list of parameters corresponding to the number of rows in a table as described herein (e.g., table 535).

In some aspects, the UE 120 may identify a bitwidth of one or more per-cell fields (e.g., an FDRA field, an MCS field, a NDI, an RV field, and/or a similar per-cell field) in the multi-cell scheduling DCI 505 based at least in part on the configuration of the co-scheduled cell indicator field 530. As used herein, a bitwidth of a field may refer to a quantity of bits (sometimes referred to herein as N) associated with the field in the multi-cell scheduling DCI 505. In some aspects, the UE 120 may identify the bitwidth associated with the field by identifying a necessary quantity of bits for the field in connection with the co-scheduled cell indicator indicating a subset of cells, of potential subsets of cells that can be indicated by the co-scheduled cell indicator field, that maximizes the bitwidth. For example, in some aspects, the UE 120 may derive the necessary quantity of bits (e.g., N) for an FDRA field, an MCs field, a NDI field, an RV field, or a similar field when the multi-cell scheduling DCI 505 schedules PUSCHs or PDSCHs over a maximum quantity of cells in a set of cells indicated by the table 535.

More particularly, in the example depicted in FIG. 6A, the table 535 indicates that the co-scheduled cell indicator field 530 may indicate one of a first subset of cells (e.g., cells #1 and #2) by using codepoint 00, a second subset of cells (e.g., cells #3 and #4) by using codepoint 01, a third subset of cells (e.g., cells #1, #2, and #3) by using codepoint 10, or a fourth subset of cells (e.g., cells #1, #2, #3, and #4) by using codepoint 11. In that regard, because the fourth subset of cells associated with codepoint 11 includes the most cells of all the potential sets of cells (and thus, in this example, the largest requirement of bits for the field), the UE 120 may use the fourth subset of cells to identify a bitwidth of the field in the DCI communication (e.g., to derive N).

More particularly, because the fourth subset of cells includes cell #1, cell #2, cell #3, and cell #4, the UE 120 may identify a first set of bits 605 necessary for indicating information associated with the field for cell #1 when codepoint 11 is used, a second set of bits 610 necessary for indicating information associated with the field for cell #2 when codepoint 11 is used, a third set of bits 615 necessary for indicating information associated with the field for cell #3 when codepoint 11 is used, and a fourth set of bits 620 necessary for indicating information associated with the field for cell #4 when codepoint 11 is used. These bits (e.g., the first set of bits 605, the second set of bits 610, the third set of bits 615, and the fourth set of bits 620) may collectively form the field bitwidth 625. Put another way, a sum of the first set of bits 605, the second set of bits 610, the third set of bits 615, and the fourth set of bits 620 may be equal to N. In some aspects, the first set of bits 605, the second set of bits 610, the third set of bits 615, and the fourth set of bits 620 may be identified by the UE 120 based at least in part on certain configuration parameters. For example, in aspects in which the field is an FDRA field, the UE 120 may identify the first set of bits 605, the second set of bits 610, the third set of bits 615, and the fourth set of bits 620 (and thus N as the sum of four sets of bits) based at least in part on a BWP size of a corresponding cell and/or a resource block group (RBG) size of a corresponding cell.

As shown in FIG. 6B, in some aspects, a quantity of bits actually used in the multi-cell scheduling DCI field for a given cell may be greater than a size of the set of bits 605, 610, 615, 620 determined by the UE 120 for purposes of deriving N. More particularly, in aspects in which a quantity of co-scheduled cells is less than a quantity of cells used to derive N, the bitwidth of the portion of the field used for each co-scheduled cell may be larger than the bitwidth of the corresponding set of bits 605, 610, 615, 620 used to derive N, subject to the condition that the total quantity of bits used for the field does not exceed N. In the example shown in FIG. 6B, the co-scheduled cell indicator field 530 indicates codepoint 00, corresponding to the first set of cells (e.g., cell #1 and cell #2). Accordingly, the field may include bits used for the first cell 630 and bits used for the second cell 632. As shown in FIG. 1, the bits used for the first cell 630 includes more bits than the first set of bits 605 (e.g., the quantity of bits allocated to cell #1 when deriving N) and the bits used for the second cell 632 includes more bits than the second set of bits 610 (e.g., the quantity of bits allocated to cell #1 when deriving N). Nonetheless, the sum of the bits used for the first cell 630 and the bits used for the second cell 632 are less than or equal to N (e.g., the bits actually used in the field may be less than or equal to the derived bitwidth of the field, N).

In that regard, when many cells are co-scheduled using the co-scheduled cell indicator field 530, a portion of the field allocated for each cell may be smaller than when a smaller quantity of cells are co-scheduled using the co-scheduled cell indicator field 530. For example, in aspects in which the field corresponds to an FDRA field, a coarser resource allocation granularity may be used when the multi-cell scheduling DCI 505 is used to schedule four cells (e.g., when the co-scheduled cell indicator field 530 indicates codepoint 11) than when the multi-cell scheduling DCI 505 is used to schedule two cells (e.g., when the co-scheduled cell indicator field 530 indicates codepoint 00). Put another way, when a smaller quantity of cells are co-scheduled by the multi-cell scheduling DCI 505 than a quantity of cells used to derive N, a finer resource allocation granularity may be used, thereby resulting in improved spectral efficiency by enabling scheduling flexibility improvement.

Additionally, or alternatively, when a total quantity of bits used for the field is less than the bitwidth of the field (e.g., when the total quantity of bits used for the field is less than N, as shown in FIG. 6B), there may be unused bits in the multi-cell scheduling DCI 505. In some aspects, as shown in FIG. 6C, when the total quantity of bits used for the field is smaller than N, resulting in unused bits 635 in the multi-cell scheduling DCI 505, a next field 640 in the multi-cell scheduling DCI 505 may begin from a first bit after the N bits associated with the field. In this regard, the unused bits 635 may be provided between the total quantity of bits used for the field (e.g., the bits used for the first cell 630 and the bits used for the second cell 632) and the next field 640 in the multi-cell scheduling DCI 505. Put another way, in some aspects, a start bit of the next field 640 in the multi-cell scheduling DCI 505 is fixed and does not change regardless of which cells are co-scheduled by the multi-cell scheduling DCI 505.

In some other aspects, as shown in FIG. 6D, when the total quantity of bits used for the field is smaller than N, resulting in the unused bits 635 in the multi-cell scheduling DCI 505, the next field 640 in the multi-cell scheduling DCI 505 may begin from a first bit after the bits actually used for the field (e.g., the bit occurring after the bits used for the first cell 630 and the bits used for the second cell 632). In this regard, in order to keep a constant DCI size, the unused bits 635 may be placed at an end of the multi-cell scheduling DCI 505. Put another way, in some aspects, a start bit of the next field 640 in the multi-cell scheduling DCI 505 may not be fixed but rather may change based at least in part on which cells are co-scheduled by the multi-cell scheduling DCI 505.

In some aspects, at least a portion of the unused bits 635 may be used to indicate additional information associated with at least one of the co-scheduled cells. For example, in some aspects the multi-cell scheduling DCI 505 may be used to schedule two TBs/codewords (CWs) associated with a cell, and the unused bits 635 may be used to indicate information associated with at least one of the two TBs/CWs. More particularly, in some aspects, the field may be associated with an MCS field, an NDI field, and/or an RV field. In such aspects, the total bitwidth of the MCS field, the NDI field, and/or the RV field (e.g., N) may be identified by the UE 120 such that the total bitwidth is maximum among all the co-scheduled cell combinations, in a similar manner as described above in connection with FIG. 6A. In such aspects, when a total quantity of bits used for MCS field, the NDI field, and/or the RV field for the co-scheduled cells is less than the derived bitwidth, the unused bits 635 in the MCS field, the NDI field, and/or the RV field may be used as an MCS field, an NDI field, and/or an RV field for the second TB/CW of one or more of the co-scheduled cells. Put another way, a first portion of the field (e.g., a first portion of the N bits) may be used to indicate an MCS, an NDI, and/or an RV associated with a first TB/CW of at least one co-scheduled cell, and a second portion of the field (e.g., a second portion of the N bits) may be used to indicate an MCS, an NDI, and/or an RV associated with a second TB/CW of at least one co-scheduled cell.

In some aspects, the UE 120 may be configured only with proper subsets of a configured set of cells that may be co-scheduled using the multi-cell scheduling DCI 505. For example, as shown in FIG. 6E, the UE 120 may be configured with a table 645, which may be indicate proper subsets of a set of cells (e.g., cell #1, cell #2, cell #3, and cell #4) that may be co-scheduled using the multi-cell scheduling DCI 505. More particularly, the table 645 indicates that the co-scheduled cell indicator field 530 may indicate one of a first subset of cells (e.g., cell #1) by using codepoint 00, a second subset of cells (e.g., cell #2) by using codepoint 01, a third subset of cells (e.g., cell #3 and cell #4) by using codepoint 10, or a fourth subset of cells (e.g., cell #1 and cell #2) by using codepoint 11. In that regard, and unlike the table 535 described above in connection with FIGS. 6A-6D, none of the subsets of cells includes all of the cells in the set of cells that may be co-scheduled using the multi-cell scheduling DCI 505 (e.g., none of the subsets includes all of cell #1, cell #2, cell #3, and cell #4).

In some aspects, the UE 120 may derive a necessary quantity of bits for the field (e.g., N, shown as a field bitwidth 650 in FIG. 6E) using a case where a quantity of bits needed for the field is maximum from all the possible co-scheduled cell combinations. In the example shown in FIG. 6E, the UE 120 may identify that the third subset of cells (e.g., cells #3 and #4) results in a maximum quantity of bits needed for the field, and thus the UE may use the third subset (e.g., the subset associated with codepoint 10) for identifying the field bitwidth 650 (e.g., for deriving N). Put another way, the UE 120 may compare the total quantity of bits needed for the field to indicate information associated with the first subset of cells (e.g., cell #1), the second subset of cells (e.g., cell #2), the third subset of cells (e.g., cell #3 and cell #4), and the fourth subset of cells (e.g., cell #1 and cell #2), and the UE 120 may identify the field bitwidth 650 based on the co-scheduled cells combination that results in the maximum quantity of necessary bits for the field.

More particularly, in the example shown in FIG. 6E, the UE 120 may determine that the third subset of cells results in the maximum quantity of bits for the field. Moreover, because the third subset of cells includes cells #3 and #4, the UE 120 may identify a first set of bits 655 necessary for indicating information associated with the field for cell #3 when codepoint 10 is used, and a second set of bits 660 necessary for indicating information associated with the field for cell #4 when codepoint 10 is used. These bits (e.g., the first set of bits 655 and the second set of bits 660) may collectively form the field bitwidth 650 (e.g., a sum of the first set of bits 655 and the second set of bits 660 may be equal to N). In a similar manner as described above in connection with the field bitwidth 625 in FIG. 6A, the first set of bits 655 and the second set of bits 660 may be identified by the UE 120 based at least in part on certain configuration parameters (e.g., based at least in part on a BWP size of a corresponding cell and/or an RBG size of a corresponding cell).

As shown in FIG. 6F, and in a similar manner as described above in connection with FIG. 6B, in some aspects, a quantity of bits actually used in the multi-cell scheduling DCI field for a given cell may be greater than a size of the set of bits determined by the UE 120 when deriving N. More particularly, in the example shown in FIG. 6F, the co-scheduled cell indicator field 530 indicates codepoint 00, corresponding to the first subset of cells (e.g., cell #1). Accordingly, the field may include bits used for the first cell 665. As shown in FIG. 6F, the bits used for the first cell 665 may include more bits than were allocated to the third cell and/or fourth cell when deriving N.

In some aspects, as shown in FIG. 6G, the total quantity of bits used for the field may be smaller than N, even when a same quantity of cells are co-scheduled using the multi-cell scheduling DCI 505 as were used to derive N. More particularly, as shown in FIG. 6G, the co-scheduled cell indicator field 530 indicates codepoint 11, corresponding to the fourth subset of cells (e.g., cell #1 and cell #2). Accordingly, the field may include bits used for the first cell 670 and bits used for the second cell 675. As shown in FIG. 6G, a total quantity of bits used for the field (e.g., the sum of the bits used for the first cell 670 and bits used for the second cell 675) may be smaller than N, even though N was derived using bit allocations for two cells (e.g., cell #3 and cell #4). For example, a quantity of bits used for an FDRA field corresponding to the first cell and the second cell may be smaller than a quantity of bits used for an FDRA field corresponding to the first cell and the second cell due to differences in BWP sizes among the cells, RBG sizes among the cells, or the like. As described above, in such aspects a next field in the multi-cell scheduling DCI 505 may begin at a first bit after the N bits associated with the field (as described above in connection with FIG. 6C), or else the next field 640 in the multi-cell scheduling DCI 505 may begin from a first bit after the bits actually used for the field (as described above in connection with FIG. 6D).

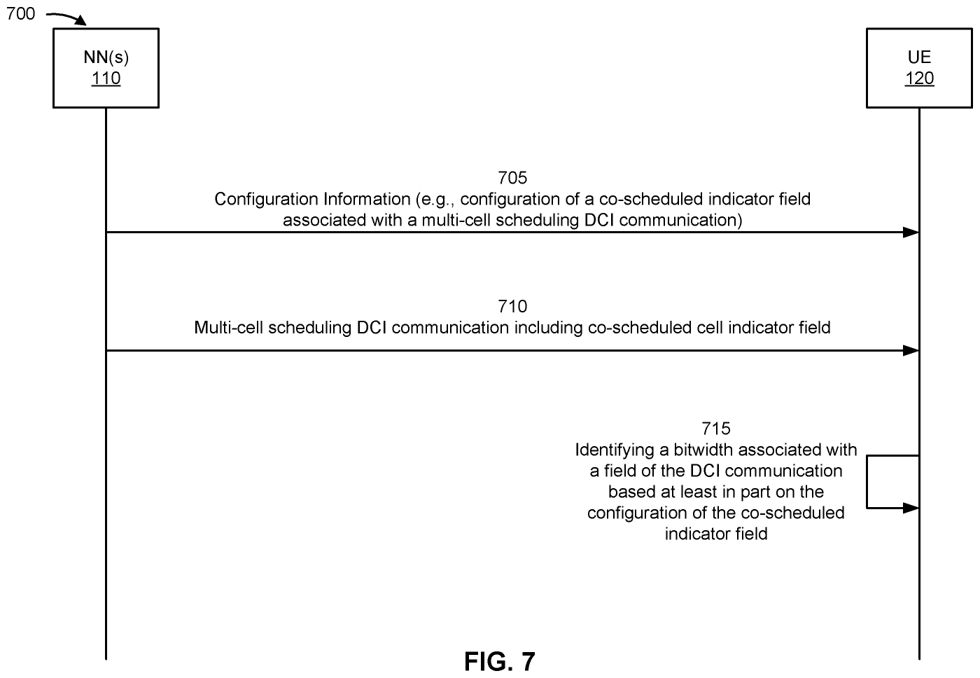

Additional aspects of a network node 110 configuring a UE 120 to receive a multi-cell scheduling DCI 505 and/or the UE 120 identifying a bitwidth of at least one field of the multi-cell scheduling DCI 505 based at least in part on a configuration of a co-scheduled cell indicator field 530 is described in more detail below in connection with FIG. 7.

As indicated above, FIGS. 6A-6G are provided as an example. Other examples may differ from what is described with respect to FIGS. 6A-6G.

FIG. 7 is a diagram of another example 700 associated with a DCI format for multi-cell scheduling, in accordance with the present disclosure. As shown in FIG. 7, a network node 110 (e.g., a CU, a DU, and/or an RU) may communicate with a UE 120. In some aspects, the network node 110 and the UE 120 may be part of a wireless network (e.g., wireless network 100). The network node 110 and the UE 120 may have established a wireless connection prior to operations shown in FIG. 7.

As shown by reference number 705, the network node 110 may transmit, and the UE 120 may receive, configuration information. In some aspects, the UE 120 may receive the configuration information via one or more of RRC signaling, one or more MAC control elements (MAC-CEs), and/or DCI, among other examples. In some aspects, the configuration information may include an indication of one or more configuration parameters (e.g., already known to the UE 120 and/or previously indicated by the network node 110 or other network device) for selection by the UE 120, and/or explicit configuration information for the UE 120 to use to configure the UE 120, among other examples.

In some aspects, the configuration information may include a configuration of a co-scheduled cell indicator field (e.g., co-scheduled cell indicator field 530) associated with a multi-cell scheduling DCI communication (e.g., multi-cell scheduling DCI 505). For example, the network node 110 may configure the UE 120 with one of the tables 535, 645 described above in connection with FIGS. 6A-6G, or a similar table. In that regard, the network node 110 may indicate to the UE 120 a set of cells that may be co-scheduled using the multi-cell scheduling DCI communication (e.g., cell #1, cell #2, cell #3, and cell #4, as described above in connection with FIGS. 6A-6G), and/or may indicate codepoints associated with the co-scheduled cell indicator field that correspond to configured subsets of the set of cells. In some aspects, the subsets may be proper subsets of the set of cells, as described above in connection with FIGS. 6E-6G.

The UE 120 may configure itself based at least in part on the configuration information. In some aspects, the UE 120 may be configured to perform one or more operations described herein based at least in part on the configuration information.

As shown by reference number 710, the network node 110 may transmit, and the UE 120 may receive, the multi-cell scheduling DCI communication. In some aspects, the multi-cell scheduling DCI communication may include a co-scheduled cell indicator field that indicates one or more cells that are scheduled by the DCI communication. More particularly, the co-scheduled cell indicator field may indicate a codepoint associated with a subset of cells (e.g., one or more cells of the four potential cells) that are co-scheduled using the multi-cell scheduling DCI communication. In some aspects, the multi-cell scheduling DCI communication may be associated with a DCI format 0_X communication, and thus the multi-cell scheduling DCI communication may co-schedule a set of cells with a PUSCH. In some other aspects, the multi-cell scheduling DCI communication may be associated with a DCI format 1_X communication, and thus the multi-cell scheduling DCI communication may co-schedule a set of cells with a PDSCH.

As shown by reference number 715, the UE 120 may identify a bitwidth associated with a field of the DCI communication based at least in part on the configuration of the co-scheduled cell indicator field. In some aspects, the field may include at least one of an FDRA field, an MCS field, an NDI field, or an RV field. Moreover, in some aspects, identifying the bitwidth associated with the field may include identifying a necessary quantity of bits for the field in connection with the co-scheduled cell indicator field indicating a set of cells, of potential sets of cells that can be indicated by the co-scheduled cell indicator field, that maximizes the bitwidth, as described above in connection with FIG. 6A. In some other aspects, the co-scheduled cell indicator field may indicate one of multiple co-scheduled cell combinations associated with the DCI communication, and identifying the bitwidth associated with the field may include the UE 120 identifying a quantity of bits necessary to schedule a co-scheduled cell combination, of the multiple co-scheduled cell combinations, that is associated with a maximum quantity of bits, such as described above in connection with FIG. 6E.

Moreover, as described above in connection with FIGS. 6B-6D and 6F-6G, in some aspects, a total quantity of bits used for the field may be less than the bitwidth, such as when less than the maximum quantity of cells is co-scheduled by the multi-cell scheduling DCI communication. Put another way, in some aspects, a total quantity of bits used for the field is less than the bitwidth associated with the field, resulting in a quantity of unused bits (e.g., the unused bits 635). For example, if the co-scheduled cell indicator field indicates a first set of cells, of various potential sets of cells indicated by the configuration information, a first quantity of bits may be associated with the field, and, if the co-scheduled cell indicator field indicates a second set of cells, of the potential sets of cells, a second quantity of bits, different from the first quantity of bits, may be associated with the field. Moreover, in aspects in which the first set of cells corresponds to the set of cells that maximizes the bitwidth, the second quantity of bits may be less than the first quantity of bits, as described above in connection with FIGS. 6B-6D and 6F-6G.

In some aspects, another field of the DCI communication that occurs directly after the field (e.g., the next field 640) may begin after the quantity of unused bits, as described above in connection with FIG. 6C. In some other aspects, the other field of the DCI communication that occurs directly after the field may begin after the total quantity of bits used for the field, and/or the quantity of unused bits may be included at an end of the DCI communication, as described above in connection with FIG. 6D. Additionally, or alternatively, in some aspects, two TBs and/or CWs may be scheduled by the DCI communication, as further described above in connection with FIG. 6D. In such aspects, the total quantity of bits used for the field may associated with a first TB/CW, of the two TBs/CWs, and at least a portion of the quantity of unused bits may be associated with a second TB/CW, of the two TBs/CWs.

In some aspects, the multi-cell scheduling DCI communication may schedule only a single cell, such as when the UE 120 is configured with the table 645 described above in connection with FIGS. 6E-6G and the co-scheduled cell indicator field indicates one of codepoint 00 or 01. In such aspects, a quantity of bits used for the field may be based at least in part on at least one of a BWP size associated with the single cell or an RBG size associated with the single cell. For example, the size of quantity of bits used for the field may be based at least in part on a wireless communication standard, such as by using a formula and/or table provided in 3GPP Technical Specification (TS) 38.214, version 17.4.0. For example, in aspects in which the field is associated with an FDRA field and only a single cell is scheduled by the multi-cell scheduling DCI communication, a quantity of bits used for the FDRA field may be identified by using legacy rules associated with identifying a bitwidth of an FDRA field for a single-cell scheduling DCI, such as the legacy rules specified by a 3GPP wireless communication standard or similar standard (e.g., a formula provided in section 5.1.2.2 of TS 38.214). For example, in aspects in which the field is associated with an FDRA field and only a single cell is scheduled by the multi-cell scheduling DCI communication, a quantity of bits used for the FDRA field may be associated with a quantity of PRBs associated with the cell and a downlink resource allocation scheme type (e.g., one of: Type 0, Configuration 1; Type 0, Configuration 2; or Type 1).

Based at least in part on the UE 120 identifying a bitwidth associated with a field of a multi-cell scheduling DCI communication based at least in part on a configuration of a co-scheduled cell indicator field associated with the DCI communication, the UE 120 and/or the network node 110 may conserve computing, power, network, and/or communication resources. For example, based at least in part on the UE 120 identifying a bitwidth associated with a field of a multi-cell scheduling DCI communication based at least in part on a configuration of a co-scheduled cell indicator field associated with the DCI communication, the UE 120 and the network node 110 may communicate with a reduced error rate and/or may eliminate overhead associated with signaling a bitwidth of the field by the network node 110 to the UE 120, which may conserve computing, power, network, and/or communication resources that may have otherwise been consumed to detect and/or correct communication errors and/or signal information about the bitwidth of one or more DCI fields.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with a DCI format for multi-cell scheduling.

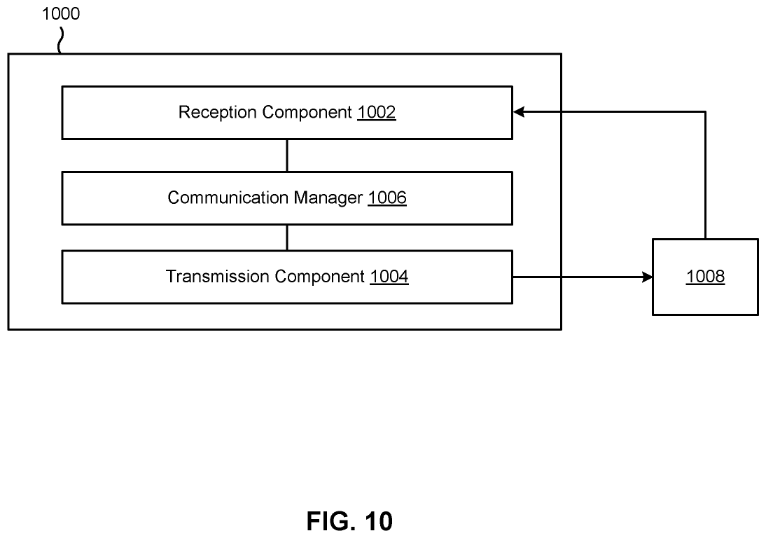

As shown in FIG. 8, in some aspects, process 800 may include receiving a multi-cell scheduling DCI communication including a co-scheduled cell indicator field that indicates one or more cells that are scheduled by the DCI communication (block 810). For example, the UE (e.g., using reception component 1002 and/or communication manager 1006, depicted in FIG. 10) may receive a multi-cell scheduling DCI communication including a co-scheduled cell indicator field that indicates one or more cells that are scheduled by the DCI communication, as described above.

As further shown in FIG. 8, in some aspects, process 800 may include identifying a bitwidth associated with a field of the DCI communication based at least in part on a configuration of the co-scheduled cell indicator field (block 820). For example, the UE (e.g., using communication manager 1006, depicted in FIG. 10) may identify a bitwidth associated with a field of the DCI communication based at least in part on a configuration of the co-scheduled cell indicator field, as described above.

Process 800 may include additional aspects, such as any single aspect or any combination of aspects described below and/or in connection with one or more other processes described elsewhere herein.

In a first aspect, the field includes at least one of a frequency domain resource allocation field, a modulation and coding scheme field, a new data indicator field, or a redundancy version field.

In a second aspect, alone or in combination with the first aspect, identifying the bitwidth associated with the field further includes identifying a necessary quantity of bits for the field in connection with the co-scheduled cell indicator field indicating a set of cells, of potential sets of cells that can be indicated by the co-scheduled cell indicator field, that maximizes the bitwidth.

In a third aspect, alone or in combination with one or more of the first and second aspects, if the co-scheduled cell indicator field indicates a first set of cells, of the potential sets of cells, a first quantity of bits is associated with the field, and, if the co-scheduled cell indicator field indicates a second set of cells, of the potential sets of cells, a second quantity of bits, different from the first quantity of bits, is associated with the field.

In a fourth aspect, alone or in combination with one or more of the first through third aspects, the first set of cells corresponds to the set of cells that maximizes the bitwidth, and the second quantity of bits is less than the first quantity of bits.

In a fifth aspect, alone or in combination with one or more of the first through fourth aspects, a total quantity of bits used for the field is less than the bitwidth associated with the field, resulting in a quantity of unused bits.

In a sixth aspect, alone or in combination with one or more of the first through fifth aspects, another field of the DCI communication that occurs directly after the field begins after the quantity of unused bits.

In a seventh aspect, alone or in combination with one or more of the first through sixth aspects, another field of the DCI communication that occurs directly after the field begins after the total quantity of bits used for the field, and the quantity of unused bits is included at an end of the DCI communication.

In an eighth aspect, alone or in combination with one or more of the first through seventh aspects, two transport blocks are scheduled by the DCI communication, the total quantity of bits used for the field is associated with a first transport block, of the two transport blocks, and at least a portion of the quantity of unused bits is associated with a second transport block, of the two transport blocks.

In a ninth aspect, alone or in combination with one or more of the first through eighth aspects, the co-scheduled cell indicator field indicates one of multiple co-scheduled cell combinations associated with the DCI communication, and identifying the bitwidth associated with the field further includes identifying a quantity of bits necessary to schedule a co-scheduled cell combination, of the multiple co-scheduled cell combinations, that is associated with a maximum quantity of bits.

In a tenth aspect, alone or in combination with one or more of the first through ninth aspects, the one or more cells includes only a single cell, and a quantity of bits used for the field is based at least in part on at least one of a bandwidth part size associated with the single cell or a resource block group size associated with the single cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with a DCI format for multi-cell scheduling.

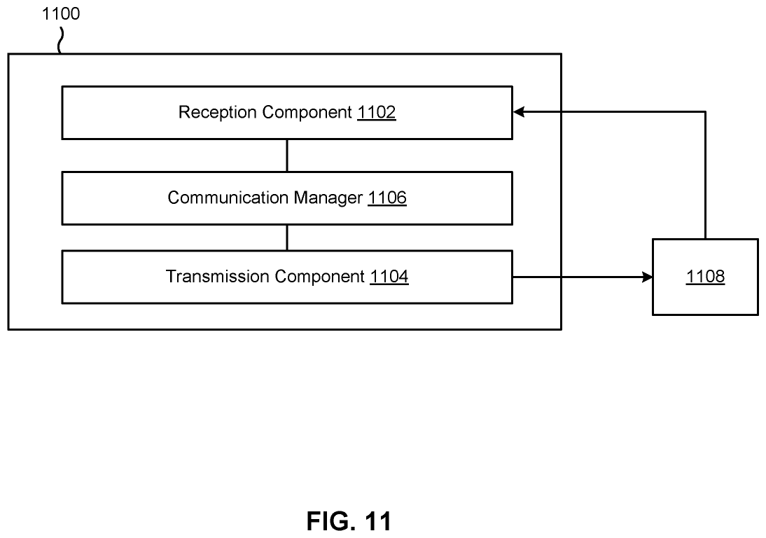

As shown in FIG. 9, in some aspects, process 900 may include transmitting, to a UE, a configuration of a co-scheduled cell indicator field associated with a multi-cell scheduling DCI communication (block 910). For example, the network node (e.g., using transmission component 1104 and/or communication manager 1106, depicted in FIG. 11) may transmit, to a UE, a configuration of a co-scheduled cell indicator field associated with a multi-cell scheduling DCI communication, as described above.

As further shown in FIG. 9, in some aspects, process 900 may include transmitting, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field (block 920). For example, the network node (e.g., using transmission component 1104 and/or communication manager 1106, depicted in FIG. 11) may transmit, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field, as described above.

Process 900 may include additional aspects, such as any single aspect or any combination of aspects described below and/or in connection with one or more other processes described elsewhere herein.

In a first aspect, the field includes at least one of a frequency domain resource allocation field, a modulation and coding scheme field, a new data indicator field, or a redundancy version field.

In a second aspect, alone or in combination with the first aspect, the bitwidth associated with the field is based at least in part on a necessary quantity of bits for the field in connection with the co-scheduled cell indicator field indicating a set of cells, of potential sets of cells that can be indicated by the co-scheduled cell indicator field, that maximizes the bitwidth.

In a third aspect, alone or in combination with one or more of the first and second aspects, if the co-scheduled cell indicator field indicates a first set of cells, of the potential sets of cells, a first quantity of bits is associated with the field, and, if the co-scheduled cell indicator field indicates a second set of cells, of the potential sets of cells, a second quantity of bits, different from the first quantity of bits, is associated with the field.

In a fourth aspect, alone or in combination with one or more of the first through third aspects, the first set of cells corresponds to the set of cells that maximizes the bitwidth, and the second quantity of bits is less than the first quantity of bits.

In a fifth aspect, alone or in combination with one or more of the first through fourth aspects, a total quantity of bits used for the field is less than the bitwidth associated with the field, resulting in a quantity of unused bits.

In a sixth aspect, alone or in combination with one or more of the first through fifth aspects, another field of the DCI communication that occurs directly after the field begins after the quantity of unused bits.

In a seventh aspect, alone or in combination with one or more of the first through sixth aspects, another field of the DCI communication that occurs directly after the field begins after the total quantity of bits used for the field, and the quantity of unused bits is included at an end of the DCI communication.

In an eighth aspect, alone or in combination with one or more of the first through seventh aspects, two transport blocks are scheduled by the DCI communication, the total quantity of bits used for the field is associated with a first transport block, of the two transport blocks, and at least a portion of the quantity of unused bits is associated with a second transport block, of the two transport blocks.

In a ninth aspect, alone or in combination with one or more of the first through eighth aspects, the co-scheduled cell indicator field indicates one of multiple co-scheduled cell combinations associated with the DCI communication, and the bitwidth associated with the field is further based at least in part on a quantity of bits necessary to schedule a co-scheduled cell combination, of the multiple co-scheduled cell combinations, that is associated with a maximum quantity of bits.

In a tenth aspect, alone or in combination with one or more of the first through ninth aspects, the one or more cells includes only a single cell, and a quantity of bits used for the field is based at least in part on at least one of a bandwidth part size associated with the single cell or a resource block group size associated with the single cell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6A-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE 120 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE 120 described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE 120 described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a multi-cell scheduling DCI communication including a co-scheduled cell indicator field that indicates one or more cells that are scheduled by the DCI communication. The communication manager 1006 may identify a bitwidth associated with a field of the DCI communication based at least in part on a configuration of the co-scheduled cell indicator field.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6A-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node 110 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node 110 described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node 110 described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a UE, a configuration of a co-scheduled cell indicator field associated with a multi-cell scheduling DCI communication. The transmission component 1104 may transmit, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving a multi-cell scheduling DCI communication including a co-scheduled cell indicator field that indicates one or more cells that are scheduled by the DCI communication; and identifying a bitwidth associated with a field of the DCI communication based at least in part on a configuration of the co-scheduled cell indicator field.

Aspect 2: The method of Aspect 1, wherein the field includes at least one of a frequency domain resource allocation field, a modulation and coding scheme field, a new data indicator field, or a redundancy version field.

Aspect 3: The method of any of Aspects 1-2, wherein identifying the bitwidth associated with the field further includes identifying a necessary quantity of bits for the field in connection with the co-scheduled cell indicator field indicating a set of cells, of potential sets of cells that can be indicated by the co-scheduled cell indicator field, that maximizes the bitwidth.

Aspect 4: The method of Aspect 3, wherein, if the co-scheduled cell indicator field indicates a first set of cells, of the potential sets of cells, a first quantity of bits is associated with the field, and wherein, if the co-scheduled cell indicator field indicates a second set of cells, of the potential sets of cells, a second quantity of bits, different from the first quantity of bits, is associated with the field.

Aspect 5: The method of Aspect 4, wherein the first set of cells corresponds to the set of cells that maximizes the bitwidth, and wherein the second quantity of bits is less than the first quantity of bits.

Aspect 6: The method of any of Aspects 1-5, wherein a total quantity of bits used for the field is less than the bitwidth associated with the field, resulting in a quantity of unused bits.

Aspect 7: The method of Aspect 6, wherein another field of the DCI communication that occurs directly after the field begins after the quantity of unused bits.

Aspect 8: The method of Aspect 6, wherein another field of the DCI communication that occurs directly after the field begins after the total quantity of bits used for the field, and wherein the quantity of unused bits is included at an end of the DCI communication.

Aspect 9: The method of Aspect 6, wherein two transport blocks are scheduled by the DCI communication, wherein the total quantity of bits used for the field is associated with a first transport block, of the two transport blocks, and wherein at least a portion of the quantity of unused bits is associated with a second transport block, of the two transport blocks.

Aspect 10: The method of any of Aspects 1-9, wherein the co-scheduled cell indicator field indicates one of multiple co-scheduled cell combinations associated with the DCI communication, and wherein identifying the bitwidth associated with the field further includes identifying a quantity of bits necessary to schedule a co-scheduled cell combination, of the multiple co-scheduled cell combinations, that is associated with a maximum quantity of bits.

Aspect 11: The method of any of Aspects 1-10, wherein the one or more cells includes only a single cell, and wherein a quantity of bits used for the field is based at least in part on at least one of a bandwidth part size associated with the single cell or a resource block group size associated with the single cell.

Aspect 12: A method of wireless communication performed by a network node, comprising: transmitting, to a UE, a configuration of a co-scheduled cell indicator field associated with a multi-cell scheduling DCI communication; and transmitting, to the UE, the multi-cell DCI communication including the co-scheduled cell indicator field that indicates one or more cells that are scheduled by the DCI communication, wherein a bitwidth associated with a field of the DCI communication is based at least in part on the configuration of the co-scheduled cell indicator field.

Aspect 13: The method of Aspect 12, wherein the field includes at least one of a frequency domain resource allocation field, a modulation and coding scheme field, a new data indicator field, or a redundancy version field.

Aspect 14: The method of any of Aspects 12-13, wherein the bitwidth associated with the field is based at least in part on a necessary quantity of bits for the field in connection with the co-scheduled cell indicator field indicating a set of cells, of potential sets of cells that can be indicated by the co-scheduled cell indicator field, that maximizes the bitwidth.

Aspect 15: The method of Aspect 14, wherein, if the co-scheduled cell indicator field indicates a first set of cells, of the potential sets of cells, a first quantity of bits is associated with the field, and wherein, if the co-scheduled cell indicator field indicates a second set of cells, of the potential sets of cells, a second quantity of bits, different from the first quantity of bits, is associated with the field.

Aspect 16: The method of Aspect 15, wherein the first set of cells corresponds to the set of cells that maximizes the bitwidth, and wherein the second quantity of bits is less than the first quantity of bits.

Aspect 17: The method of any of Aspects 12-16, wherein a total quantity of bits used for the field is less than the bitwidth associated with the field, resulting in a quantity of unused bits.

Aspect 18: The method of Aspect 17, wherein another field of the DCI communication that occurs directly after the field begins after the quantity of unused bits.

Aspect 19: The method of Aspect 17, wherein another field of the DCI communication that occurs directly after the field begins after the total quantity of bits used for the field, and wherein the quantity of unused bits is included at an end of the DCI communication.

Aspect 20: The method of Aspect 17, wherein two transport blocks are scheduled by the DCI communication, wherein the total quantity of bits used for the field is associated with a first transport block, of the two transport blocks, and wherein at least a portion of the quantity of unused bits is associated with a second transport block, of the two transport blocks.

Aspect 21: The method of any of Aspects 12-20, wherein the co-scheduled cell indicator field indicates one of multiple co-scheduled cell combinations associated with the DCI communication, and wherein the bitwidth associated with the field is further based at least in part on a quantity of bits necessary to schedule a co-scheduled cell combination, of the multiple co-scheduled cell combinations, that is associated with a maximum quantity of bits.

Aspect 22: The method of any of Aspects 12-21, wherein the one or more cells includes only a single cell, and wherein a quantity of bits used for the field is based at least in part on at least one of a bandwidth part size associated with the single cell or a resource block group size associated with the single cell.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+ a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a multi-cell scheduling downlink control information (DCI) communication including a co-scheduled cell indicator field that indicates one or more cells that are scheduled by the DCI communication; and
identify a bitwidth associated with a field of the DCI communication based at least in part on a configuration of the co-scheduled cell indicator field.

2. The UE of claim 1, wherein the field includes at least one of a frequency domain resource allocation field, a modulation and coding scheme field, a new data indicator field, or a redundancy version field.

3. The UE of claim 1, wherein the one or more processors, to identify the bitwidth associated with the field, are configured to identify a necessary quantity of bits for the field in connection with the co-scheduled cell indicator field indicating a set of cells, of potential sets of cells that can be indicated by the co-scheduled cell indicator field, that maximizes the bitwidth.

4. The UE of claim 3, wherein, if the co-scheduled cell indicator field indicates a first set of cells, of the potential sets of cells, a first quantity of bits is associated with the field, and wherein, if the co-scheduled cell indicator field indicates a second set of cells, of the potential sets of cells, a second quantity of bits, different from the first quantity of bits, is associated with the field.

5. The UE of claim 4, wherein the first set of cells corresponds to the set of cells that maximizes the bitwidth, and wherein the second quantity of bits is less than the first quantity of bits.

6. The UE of claim 1, wherein a total quantity of bits used for the field is less than the bitwidth associated with the field, resulting in a quantity of unused bits.

7. The UE of claim 6, wherein another field of the DCI communication that occurs directly after the field begins after the quantity of unused bits.

8. The UE of claim 6, wherein another field of the DCI communication that occurs directly after the field begins after the total quantity of bits used for the field, and wherein the quantity of unused bits is included at an end of the DCI communication.

9. The UE of claim 6, wherein two transport blocks are scheduled by the DCI communication, wherein the total quantity of bits used for the field is associated with a first transport block, of the two transport blocks, and wherein at least a portion of the quantity of unused bits is associated with a second transport block, of the two transport blocks.

10. The UE of claim 1, wherein the co-scheduled cell indicator field indicates one of multiple co-scheduled cell combinations associated with the DCI communication, and wherein the one or more processors, to identify the bitwidth associated with the field, are configured to identify a quantity of bits necessary to schedule a co-scheduled cell combination, of the multiple co-scheduled cell combinations, that is associated with a maximum quantity of bits.

11. The UE of claim 1, wherein the one or more cells includes only a single cell, and wherein a quantity of bits used for the field is based at least in part on at least one of a bandwidth part size associated with the single cell or a resource block group size associated with the single cell.

12. A network node for wireless communication, comprising:
a memory; and
one or more processors, coupled to the memory, configured to:
transmit, to a user equipment (UE), a configuration of a co-scheduled cell indicator field associated with a multi-cell scheduling downlink control information (DCI) communication; and
transmit, to the UE, the multi-cell scheduling DCI communication including the co-scheduled cell indicator field that indicates one or more cells that are scheduled by the DCI communication, wherein a bitwidth associated with a field of the DCI communication is based at least in part on the configuration of the co-scheduled cell indicator field.

13. The network node of claim 12, wherein the field includes at least one of a frequency domain resource allocation field, a modulation and coding scheme field, a new data indicator field, or a redundancy version field.

14. The network node of claim 12, wherein the bitwidth associated with the field is based at least in part on a necessary quantity of bits for the field in connection with the co-scheduled cell indicator field indicating a set of cells, of potential sets of cells that can be indicated by the co-scheduled cell indicator field, that maximizes the bitwidth.

15. The network node of claim 14, wherein, if the co-scheduled cell indicator field indicates a first set of cells, of the potential sets of cells, a first quantity of bits is associated with the field, and wherein, if the co-scheduled cell indicator field indicates a second set of cells, of the potential sets of cells, a second quantity of bits, different from the first quantity of bits, is associated with the field.

16. The network node of claim 15, wherein the first set of cells corresponds to the set of cells that maximizes the bitwidth, and wherein the second quantity of bits is less than the first quantity of bits.

17. The network node of claim 12, wherein a total quantity of bits used for the field is less than the bitwidth associated with the field, resulting in a quantity of unused bits.

18. The network node of claim 17, wherein another field of the DCI communication that occurs directly after the field begins after the quantity of unused bits.

19. The network node of claim 17, wherein another field of the DCI communication that occurs directly after the field begins after the total quantity of bits used for the field, and wherein the quantity of unused bits is included at an end of the DCI communication.

20. The network node of claim 17, wherein two transport blocks are scheduled by the DCI communication, wherein the total quantity of bits used for the field is associated with a first transport block, of the two transport blocks, and wherein at least a portion of the quantity of unused bits is associated with a second transport block, of the two transport blocks.

21. The network node of claim 12, wherein the co-scheduled cell indicator field indicates one of multiple co-scheduled cell combinations associated with the DCI communication, and wherein the bitwidth associated with the field is further based at least in part on a quantity of bits necessary to schedule a co-scheduled cell combination, of the multiple co-scheduled cell combinations, that is associated with a maximum quantity of bits.

22. The network node of claim 12, wherein the one or more cells includes only a single cell, and wherein a quantity of bits used for the field is based at least in part on at least one of a bandwidth part size associated with the single cell or a resource block group size associated with the single cell.

23. A method of wireless communication performed by a user equipment (UE), comprising:
receiving a multi-cell scheduling downlink control information (DCI) communication including a co-scheduled cell indicator field that indicates one or more cells that are scheduled by the DCI communication; and
identifying a bitwidth associated with a field of the DCI communication based at least in part on a configuration of the co-scheduled cell indicator field.

24. The method of claim 23, wherein the field includes at least one of a frequency domain resource allocation field, a modulation and coding scheme field, a new data indicator field, or a redundancy version field.

25. The method of claim 23, wherein identifying the bitwidth associated with the field further includes identifying a necessary quantity of bits for the field in connection with the co-scheduled cell indicator field indicating a set of cells, of potential sets of cells that can be indicated by the co-scheduled cell indicator field, that maximizes the bitwidth.

26. The method of claim 25, wherein, if the co-scheduled cell indicator field indicates a first set of cells, of the potential sets of cells, a first quantity of bits is associated with the field, and wherein, if the co-scheduled cell indicator field indicates a second set of cells, of the potential sets of cells, a second quantity of bits, different from the first quantity of bits, is associated with the field.

27. The method of claim 26, wherein the first set of cells corresponds to the set of cells that maximizes the bitwidth, and wherein the second quantity of bits is less than the first quantity of bits.

28. A method of wireless communication performed by a network node, comprising:
transmitting, to a user equipment (UE), a configuration of a co-scheduled cell indicator field associated with a multi-cell scheduling downlink control information (DCI) communication; and
transmitting, to the UE, the multi-cell scheduling DCI communication including the co-scheduled cell indicator field that indicates one or more cells that are scheduled by the DCI communication, wherein a bitwidth associated with a field of the DCI communication is based at least in part on the configuration of the co-scheduled cell indicator field.

29. The method of claim 28, wherein the bitwidth associated with the field is based at least in part on a necessary quantity of bits for the field in connection with the co-scheduled cell indicator field indicating a set of cells, of potential sets of cells that can be indicated by the co-scheduled cell indicator field, that maximizes the bitwidth.

30. The method of claim 28, wherein the co-scheduled cell indicator field indicates one of multiple co-scheduled cell combinations associated with the DCI communication, and wherein the bitwidth associated with the field is further based at least in part on a quantity of bits necessary to schedule a co-scheduled cell combination, of the multiple co-scheduled cell combinations, that is associated with a maximum quantity of bits.
